(19) United States
(12) Patent Application Publication
(10) Pub. No.: US 2017/0298716 A1
(43) Pub. Date: Oct. 19, 2017

(54) APPARATUS FOR MORE EFFECTIVELY EXTRACTING ENERGY RESOURCES FROM UNDERGROUND RESERVOIRS AND A METHOD FOR MANUFACTURING THE SAME

(71) Applicants: Taylor McConnell, Wexford, PA (US); Scott S. Brunner, St Mary's, PA (US); Alan R. Keniston, St Mary's, PA (US)

(72) Inventors: Taylor McConnell, Wexford, PA (US); Scott S. Brunner, St Mary's, PA (US); Alan R. Keniston, St Mary's, PA (US)

(21) Appl. No.: 15/453,112

(22) Filed: Mar. 8, 2017

Related U.S. Application Data
(60) Provisional application No. 62/305,666, filed on Mar. 9, 2016.

(51) Int. Cl. E21B 43/119; E21B 43/116; B23C 3/02; B23C 5/10

(52) U.S. Cl. CPC E21B 43/119; B23C 5/1009; E21B 43/116; B23C 3/02; B23C 2220/08; B23C 2220/32; B23C 2220/24

(57) ABSTRACT

An apparatus for more effectively extracting energy resources from underground reservoirs and a method for manufacturing the same. The apparatus is a perforating gun that includes scallops shaped such that charges that are displaced from their original location nevertheless remain located below the scallop, which increases the effectiveness of displaced charges when detonated. In addition, the scallops are created using a method that enables the entire scallop to be of a uniform thickness, which also increases the effectiveness of charges detonated beneath the scallop.

### CLAIM OF PRIORITY

This utility application claims the benefit of U.S. Provisional Patent Application No. 62/305,666, which was filed Mar. 9, 2016.

### FIELD OF THE INVENTION

This invention relates to perforating guns and, more specifically, to increasing the effectiveness of perforating guns by increasing the likelihood that charges remain located below a scalloped surface and by manufacturing the scallops to a substantially uniform thickness.

### BACKGROUND OF THE INVENTION

Perforating guns are devices that are commonly used within the energy industry in order to facilitate the extraction of energy resources from the ground. Energy resources, such as oil and natural gas, are generally found in underground reservoirs. In order to extract the oil or gas, a drill is often used to drill a long vertical hole from the ground surface downward into the reservoir. By “tapping” the reservoir in this way, the oil or natural gas contained in the reservoir can be brought to the surface through the newly-made vertical hole.

Energy resource reservoirs, however, often span large horizontal distances. A single reservoir may occupy many square acres or even many square miles of underground space. Reservoirs also occupy a certain vertical space underground; by way of example, the “top” of a reservoir may be located two hundred (200) feet below the surface, but the “bottom” of the reservoir may be located eight hundred (800) feet below the surface. A drill that bores a vertical hole can access all “heights” of a reservoir; to extract oil or gas located deeper in the ground (i.e., more toward the reservoir's “bottom”), the person operating the drill need only drill deeper.

But a single vertically drilled hole is only able to access a reservoir at one location relative to the reservoir's horizontal breadth. It is unfeasible to drill scores (or more) of vertical holes in order to access the entirety of a reservoir's horizontal breadth. One method of accessing a reservoir's horizontal breadth without drilling multiple vertical holes is to expand the subterranean portion of a vertical hole in a horizontal direction. By expanding the subterranean portion of a vertical hole in a horizontal direction, oil and gas located a horizontal distance from the vertical hole can still be extracted through the vertical hole.

One method of expanding the subterranean portion of a vertical hole in a horizontal direction is via a controlled subterranean explosion. The controlled subterranean explosion displaces earth (such dirt, rock, or whatever earthen material lines the vertically drilled hole), and by doing so broadens the vertical hole horizontally.

Perforating guns are a device used to cause and control subterranean explosions to horizontally broaden vertical holes drilled to access energy resources. A drawing of a perforating gun is included herewith at Reference No. 1 in FIG. 1. Perforating guns are typically cylindrical and contain strategically placed indentations known as “scallops.” Scallops are marked by Ref. No. 7 in FIG. 1. Some scallops in a perforating gun (but not necessarily all scallops) are “loaded” with a charge. A charge is explosive material that, as loaded, is positioned below a scallop. A charge situated in a perforating gun below a scallop can be seen at Ref. No. 4 in FIG. 2. FIG. 3 shows a charge standing alone.

In the current state of the art, charges loaded in perforating guns are approximately the same size as the scallops under which the charges are located. As explained further herein, in practice charges do not always remain positioned directly below a scallop. When this happens, the topmost portion of the charge that was originally located directly below the scallop and from which the explosive force of the charge emanates (referred to herein as the “charge head”) becomes located in a position such that at least a portion of the charge head is not located beneath a scallop. This is a problem that the invention disclosed herein seeks to solve.

In order to accomplish the controlled subterranean explosion, one or more perforating guns are lowered into the vertical hole that was initially drilled to tap the reservoir. When multiple perforating guns are connected in an end-to-end manner and simultaneously lowered into the same vertical hole, it is commonly known as a “string” of perforating guns. There are a variety of well-known methods for lowering perforating guns into a vertical hole. When perforating guns are lowered to the desired depth, the charges situated beneath the scallops are detonated.

Because the scallops are an indentation, the thickness of the perforating gun is less at a scallop than at unscalloped parts of the perforating gun. See FIG. 1, Ref. No. 7. As a result of the lesser thickness, when a charge below a scallop is detonated, the force of the detonation from the charge is channeled through and expelled from the scallop. In this way, the indentations that form scallops serve as “holes” that are “punched out” when a charge located below the scallop is detonated (but to be clear, because the indentations that form scallops do not completely penetrate the walls of a perforating gun, scallops are not truly “holes” until the charges beneath the scallops are detonated).

When the force of a charge detonated below a scallop is channeled through and expelled from the scallop, the channeled force displaces the earthen material located directly adjacent to the scallop, creating fissures in the adjacent earthen material. A series of drawings exemplifying the process by which perforating guns are lowered into a vertical hole and then detonated to create fissures is included herewith as FIG. 9 and FIG. 10.

One variation of charge used in perforating guns contains an amount of copper situated atop the charge but below the scallop. When the charge is detonated, the copper sitting atop is liquefied as a result of the heat generated by the detonation. In addition to liquefying the copper, the explosive force of the charge expels the molten copper through the scallop. When the molten copper is expelled through the scallop, its function is tantamount to a liquid drill: the molten copper strikes the earthen material adjacent to the scallop from which it was expelled, and in doing so bores through the earthen material to create fissures through which energy resources can flow.

As noted above, charges do not always remain situated directly below the scallops through which their explosion is intended to be channeled. This is due to the jarring forces that perforating guns experience during the process of being inserted into vertically drilled holes. Such displacement can also result from jarring forces that an undetonated perforating gun sustains when another perforating gun is detonated in the same vertically drilled hole. This occurs because all depths of a vertically drilled hole are not necessarily expanded via perforating guns at the same time. Any difference in timing between the detonation of perforating guns on the same string can result in the explosive force from a detonated perforating gun displacing the charges held within an undetonated perforating gun.

Even a slight displacement of a charge can reduce the efficacy of a perforating gun. This is because when the charge is displaced, it no longer aligns perfectly with the scallop. When the charge is later detonated, the explosive force (or liquefied copper) no longer passes directly through the scallop. Instead, the force generated from the portion of the charge head that is no longer located directly below the scallop must penetrate an unscalloped portion of the perforating gun. Because a greater amount of force is consumed to penetrate the unscalloped portion of the perforating gun than a scalloped portion (due to the increased thickness that is found at unscalloped portions of the perforating gun), there is a lesser amount of force available to penetrate the earthen material located adjacent to the perforating gun. As a result, the fissures created by the detonation of displaced charges do not reach as far horizontally as the fissures created by the detonation of charges that remain situated directly below the scallops through which their explosive force is intended to be channeled. Furthermore, when a displaced charge's explosive force strikes an unscalloped portion of a perforating gun, an increased amount of the explosive force is channeled vertically up and down the length the perforating gun itself. This further reduces the amount of explosive force that is available to displace earthen material once the displaced charge penetrates the unscalloped portion of the perforating gun. Finally, when a displaced charge penetrates the unscalloped portion of a perforating gun, the perforating gun is often damaged and fragments of the perforating gun can become lodged in the fissures created by detonation, thereby impeding the flow of energy resources from the fissures into the vertical hole.

To reduce the problems created when charges become displaced, it is an industry goal to ensure that as much of a charge's explosive force as possible is expelled directly through a scallop. The invention disclosed herein seeks to accomplish that goal by altering the shape of scallops. And although perforating guns are well-known in the art (see, e.g., U.S. Pat. No. 9,441,438; U.S. Pat. No. 8,684,083; U.S. Pat. No. 8,424,606; and similar prior art), Applicant's research has not revealed prior art that discloses the invention disclosed herein.

As noted above, numerous problems result when a charge penetrates an unscalloped portion of a perforating gun. However, the industry does not currently engineer scallops to a substantially uniform thickness. This is because perforating guns are cylindrical in shape (like a pipe). Scallops are currently engineered by using a device to bore directly down upon the curved outer surface of a perforating gun. But boring directly downward upon a perforating gun's curved outer surface results in scallops that are thinner at their center than at their edges. The lack of substantial uniformity in scallop thickness created by the industry's current scallop making process can be seen in FIGS. 5 and 6. The edges of scallops being thicker than the center means that some of the force generated by a charge must penetrate a thicker amount of the perforating gun's wall, even if the charge remains situated directly below the scallop. See FIGS. 5 and 6. As a result, even charges that are not displaced suffer to an extent from the problems that occur when a charge is displaced and must penetrate an unscalloped portion of a perforating gun.

The invention disclosed herein improves upon the scallop making process by ensuring that scallops are substantially as thin at their edges as they are at their center.

### SUMMARY OF THE INVENTION

The present invention provides a perforating gun with scallops shaped such that a charge that is dislocated from its original position will still remain entirely below the scallop under which the charge was originally located or, at the very least, more of the charge head will remain below the scallop under which the charge was originally located than if the scallop was circular shaped (which is the current state of the art). The present invention also provides a method for milling scallops such that the scallop is of a substantially uniform thickness.

### BRIEF DESCRIPTION OF THE DRAWINGS

The drawings included herewith are not intended to in any way limit the scope of the invention disclosed herein. The drawings are merely included to clarify and exemplify the invention as disclosed and claimed herein.

FIG. 1 shows a standard perforating gun with standard circular-shaped scallops and a cross-sectional view of the same.

FIG. 2 shows a cross-sectional and standard view of a perforating gun with charges loaded below circular scallops.

FIG. 3 shows a standard charge that may be loaded beneath a scallop in a perforating gun.

FIG. 4 shows a comparative view of a perforating gun with elliptical shaped scallops and a perforating gun with circular shaped scallops.

FIG. 5 shows the milling of a scallop in a perforating gun using the industry's current method, which does not create scallops of substantially uniform thickness.

FIG. 6 shows a scallop created using the industry's current method; note the scallop is not of substantially uniform thickness.

FIG. 7 shows an example of the method of creating scallops claimed herein, which creates scallops of substantially uniform thickness.

FIG. 8 shows a scallop created using the method claimed herein; note the scallop's substantially uniform thickness.

FIG. 9 shows generally how perforating guns are used to create subterranean fissures that facilitate the extraction of energy resources.

FIG. 10 shows generally how perforating guns are used to create subterranean fissures that facilitate the extraction of energy resources.

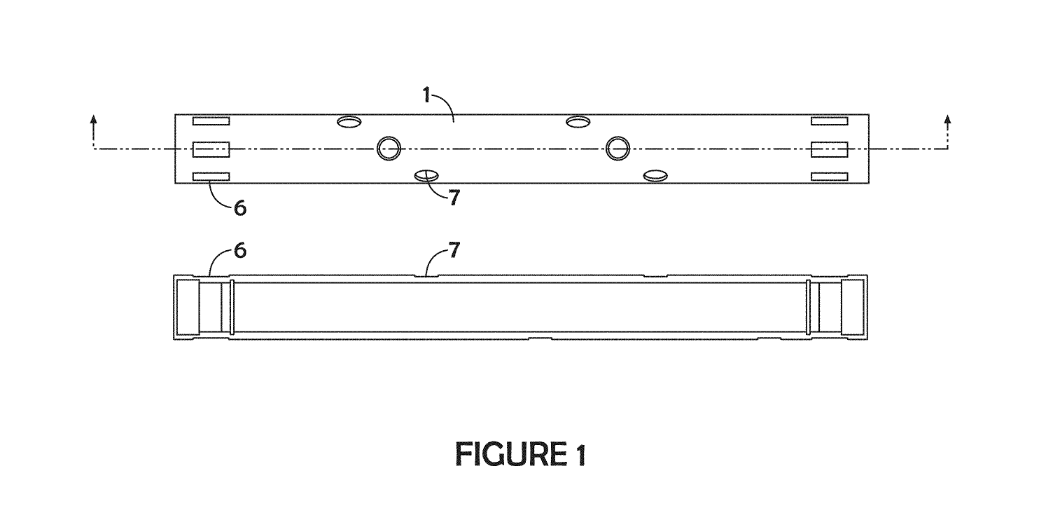

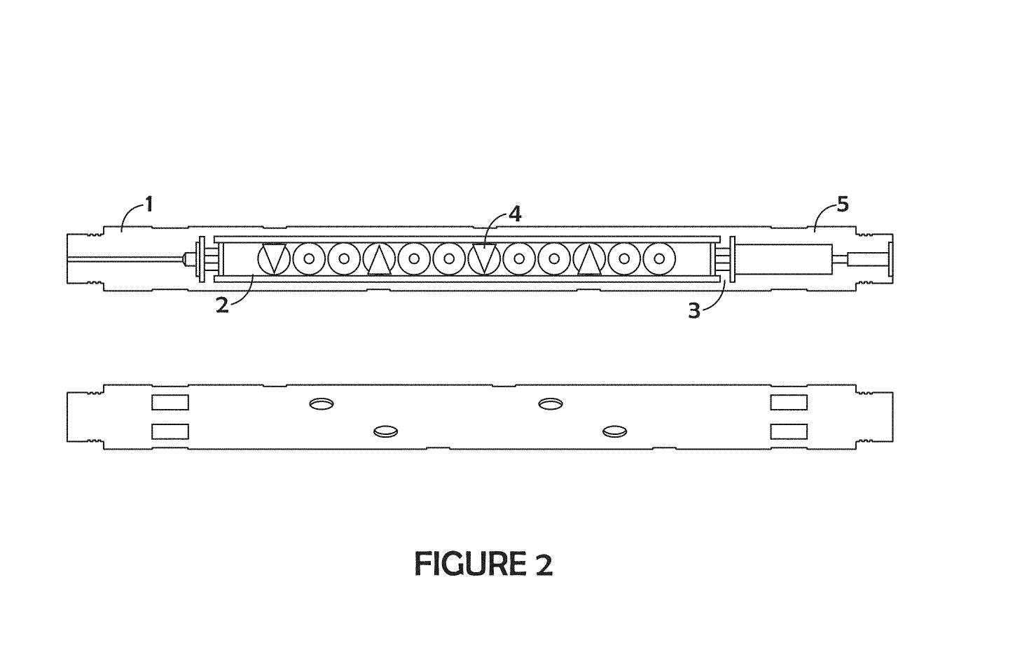

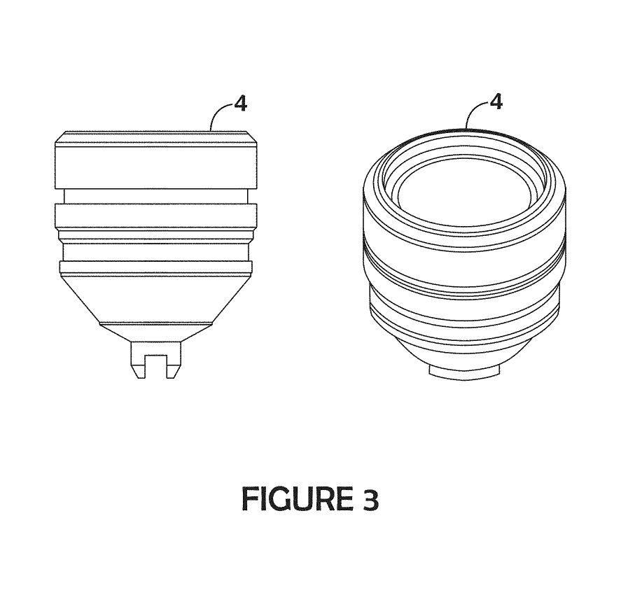

### DETAILED DESCRIPTION OF THE INVENTION

When a charge below a scallop is displaced, it typically shifts such that only a portion of the charge head is no longer situated below the scallop. The present invention provides a perforating gun with scallops shaped such that the surface area occupied by the scallop is sufficiently larger than the size of the charge head below the scallop, so that if the charge below the scallop is shifted in location, there is an increased likelihood that all or the majority of the charge head will remain located below the scallop notwithstanding that the charge has moved from its original location.

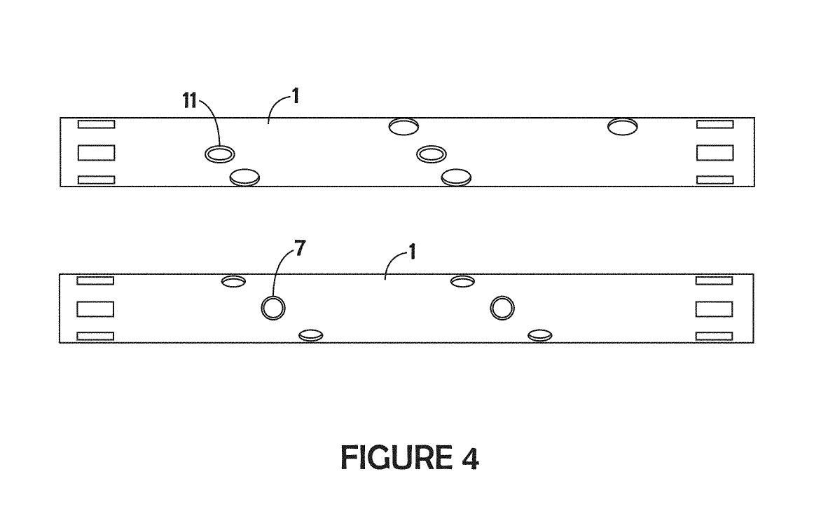

Referring to FIG. 4, a preferred embodiment of the present invention includes the use of elliptical shaped scallops 11. Elliptical scallops 11 provide better performance in perforating guns because by elongating the scallop beyond the art's current use of circular scallops, if a charge is displaced along the longitudinal axis of the elliptical scallop, the charge still remains situated below a scalloped portion of the perforating gun rather than becoming situated below an unscalloped portion of the perforating gun. The advantage of including elliptical scallops 11 can be easily seen when the elliptical scallops 11 are compared to the circular scallops 7 also shown in FIG. 4. If a charge situated below a circular scallop 7 is displaced, at least a portion of the charge will be located below an unscalloped portion of the perforating gun. Thus, by increasing the likelihood that a charge displaced from its original location remains situated below a scalloped portion of a perforating gun, the invention disclosed herein increases the likelihood that as much of a charge's explosive force as possible is expelled directly through a scallop, even if the charge sustains a pre-detonation jarring force that displaces the charge from its original location.

The elliptical scallops 11 are further desirable as a preferred embodiment because, while they permit a dislocated charge to remain below a scallop, the elliptical shape is not so much larger than the charges that the explosive force created by the charges is expelled too diffusely to effectively create fissures in the earthen material adjacent to the perforating gun. If a scallop design is too large, the explosive force generated by the charge below the scallop may be expelled from the scallop too diffusely to penetrate the earthen material deeply enough to effectively extract natural resource reserves.

Elliptical scallops 11 are discussed herein only as an example. Any shape or size of scallop that permits a displaced charge to remain located below a scalloped portion of a perforating gun should be considered within the scope of the invention disclosed herein. The essence of the invention, therefore, is fashioning scallops in perforating guns such that a displaced charge remains located below a scalloped portion of the perforating gun, notwithstanding that it has been displaced from its original location.

Referring now to FIG. 8, the present invention also includes scallops that are engineered such that the scallop is of a substantially uniform thickness 10. As explained above, the advantage of charges penetrating thinner portions of the perforating gun (such as scallops) is that less force from the blast is required to penetrate the thinner portion of the perforating gun and so more force remains available to penetrate the earthen material located adjacent to the gun. The advantage of scallops of substantially uniform thickness 10, as compared to scallops currently utilized by the industry that are thicker at their edges than at their center (See FIG. 6), is that substantially all of the substantially uniformly thin scallops provide a thinner surface for charges to penetrate. Including scallops of substantially uniform thickness 10 thus further conserves the amount of a charge's detonation force that is needed to penetrate a scallop, which results in more of the charge's force remaining available to penetrate the earthen material adjacent to the perforating gun.

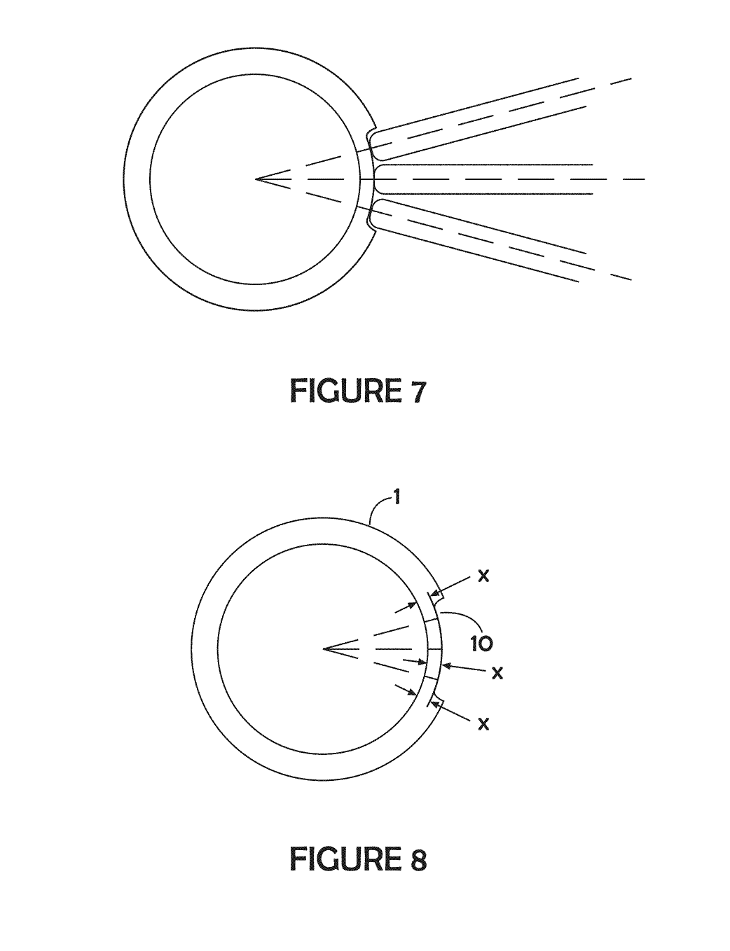

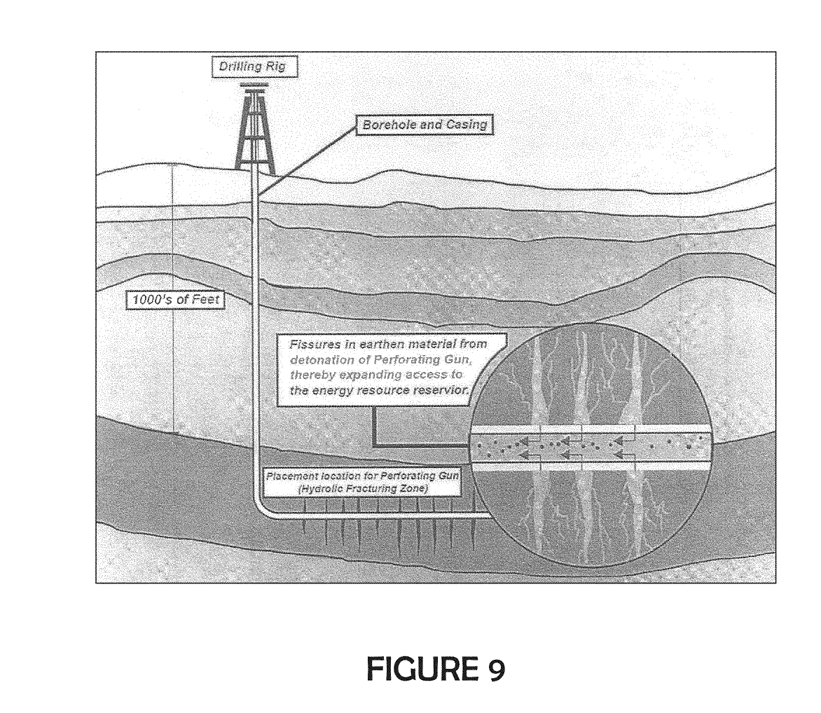

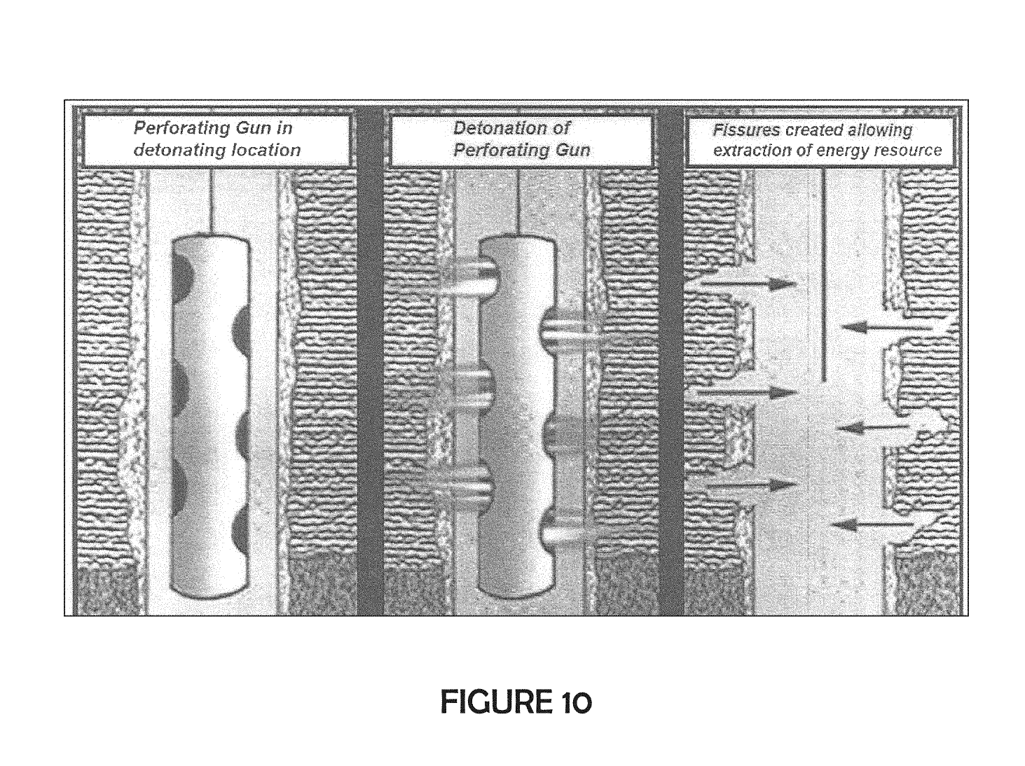

Referring now to FIGS. 7 and 8, the present invention also discloses a method for creating scallops of a substantially uniform thickness 10. Shown in FIG. 7 is a multi-compound tool that has the ability to generate the radial scallop floor concentric to the inner diameter of the perforating gun, which allows the scallop to maintain a substantially uniform thickness for the charge to penetrate. One such multi-compound tool currently available is a 5 Axis Multi Task Machine (“MTM”) and a ball nose end mill;

however, persons will skill in the art will recognize that other multi-compound tools exist that are capable of generating scallops such that the scallop is of a substantially uniform thickness.

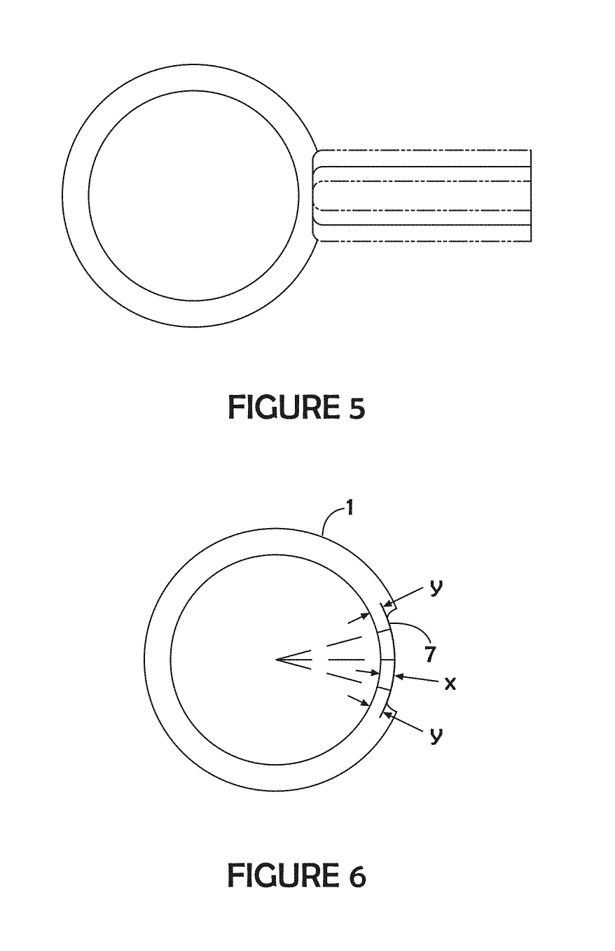

The advantage of using a multi-compound tool as shown in FIG. 7 is readily apparent when comparing FIG. 7 and FIG. 8 to FIG. 5 and FIG. 6. FIG. 5 shows the current method that the industry uses for creating scallops, where a non-multi-compound tool (such as, for example, a 3 Axis MTM and bullnose end mill) is lowered upon the perforating gun surface by lowering the tool along a single axis. But because perforating guns are cylindrical, lowering the non-multi-compound milling tool along such a single axis downward upon a perforating gun's curved outer surface results in scallops that are thinner at their center than at their edges (See FIG. 6). Unlike the scallops of substantially uniform thickness 10 disclosed herein, such non-substantially uniformly thick scallops require more force to penetrate the scallop's thicker edges, which, as explained above, reduces the effectiveness of the charge's explosion to create fissures that allow for harvesting of energy resources.

Having thus described the invention, what is desired to be protected by Letters Patent is presented in the subsequently appended claims.

What is claimed is:

1. A perforating gun comprising:
a) an elongated body;
b) wherein the elongated body includes at least one scallop; and
c) wherein the at least one scallop is engineered such that the surface area of the scallop is sufficiently larger than a charge head of a charge that may be located beneath the scallop, such that if the charge is displaced from its original location, the charge head will be more likely to remain located beneath the scallop.

2. The perforating gun claimed in claim 1, wherein the at least one scallop is elliptical shaped.

3. The perforating gun claimed in claim 1, wherein the at least one scallop is engineered such that the scallop is of a substantially uniform thickness.

4. The perforating gun claimed in claimed in claim 2, wherein the at least one scallop is of a substantially uniform thickness.

5. A perforating gun comprising:
a) an elongated body;
b) wherein the elongated body includes at least one scallop; and
c) wherein the at least one scallop is engineered such that the scallop is of a substantially uniform thickness.

6. A method for engineering at least one scallop of a perforating gun such that the at least one scallop is of a substantially uniform thickness, including:
a) a multi-compound milling tool; and
b) wherein the multi-compound milling tool is bored upon an elongated body of a perforating gun such that a scallop created by such boring is of a substantially uniform thickness.
